(19) United States
(12) Patent Application Publication
(10) Pub. No.: US 2003/0103287 A1
(43) Pub. Date: Jun. 5, 2003

(54) Disk drive apparatus

(76) Inventor: Masaya Agematsu, Akishima-shi (JP)

Correspondence Address: PILLSBURY WINTHROP, LLP, P.O. BOX 10500, MCLEAN, VA, 22102, US

(21) Appl. No.: 10/234,714

(22) Filed: Sep. 5, 2002

(30) Foreign Application Priority Data
Nov. 30, 2001 (JP) 2001-367243

(51) Int. Cl. G11B 19/04; G11B 21/02

(52) U.S. Cl. 360/60; 360/75

(57) ABSTRACT

A disk drive apparatus includes a drive section, which has a disk, a motor for supporting and rotating the disk, a head configured to perform an information processing operation with respect to the disk, and a head actuator supporting the head for movement relative to the disk, and a shock sensor for detecting the respective levels of a shock and a vibration externally applied to the drive section. The apparatus includes a compensation filter for amplifying the shock and vibration levels in a frequency band corresponding to the resonance frequency of the drive section, out of the shock and vibration levels detected by means of the shock sensor. A control section stops the information processing operation of the head when given values are exceeded by the external shock and vibration levels detected by means of the shock sensor and inputted through the compensation filter.

### CROSS REFERENCE TO RELATED APPLICATIONS

This application is based upon and claims the benefit of priority from the prior Japanese Patent Application No. 2001-367243, filed Nov. 30, 2001, the entire contents of which are incorporated herein by reference.

### BACKGROUND OF THE INVENTION

1. Field of the Invention

The present invention relates to a disk drive apparatus furnished with a shock sensor.

2. Description of the Related Art

Optical and magnetic disk drives are widely used as recording/reproducing apparatuses for modern computers. For example, a hard disk drive (hereinafter referred to as an HDD) generally comprises a magnetic disk disposed in a casing, a spindle motor for supporting and rotating the magnetic disk, a rotary head actuator supporting magnetic heads, a voice coil motor for driving the head actuator, a substrate unit, etc. Further, a printed circuit board for controlling the operation of the HDD is provided on the outer surface of the bottom wall of the casing.

The head actuator is provided with a bearing portion attached to the casing, a plurality of arms extending from the bearing portion, and suspensions extending individually from the arms. The magnetic heads are attached individually to the respective extending ends of the suspensions. A voice coil that constitutes the voice coil motor is provided on that end portion of the head actuator which is remoter from the magnetic heads.

Usually, the HDD is provided with a shock sensor (acceleration sensor) for detecting external shocks or vibrations. It is designed to interrupt recording operation by means of the magnetic heads or carry out feedforward control in response to a detection signal from the shock sensor if the sensor detects any external shock or vibration that exceeds a given value. Thus, the HDD can prevent erratic operation when it is subjected to a substantial shock or vibration. Conventionally, the shock sensor is set on the printed circuit board that is provided on the outer surface of the bottom wall of the casing.

Normally, the frequency characteristic of a shock sensor system, that is, the frequency characteristic to which the shock sensor reacts, is different from that of a drive system of the HDD. For example, the frequency characteristic of the drive system of the HDD covers resonance frequencies that are attributable to the vibration of the spindle motor, operation of the head actuator, etc. On the other hand, the frequency characteristic of the head actuator has a peak in a frequency band higher than that of the resonance frequency.

If the HDD is subjected to any external vibration or shock in a frequency band substantially equivalent to that of the resonance frequency of the drive system, therefore, its response is more sensitive than in other frequency bands. Although it is hard to position the head actuator, therefore, the shock sensor inevitably fails to react.

If the sensitivity of the shock sensor is only simply increased, on the other hand, the sensor reacts to other frequencies than the aforesaid resonance frequency, and frequently interrupts information processing operation by means of the magnetic heads even if the applied vibration or shock constitutes no hindrance to the operation. In consequence, the capacity of the HDD is lessened.

### BRIEF SUMMARY OF THE INVENTION

The present invention has been contrived in consideration of these circumstances, and its object is to provide a disk drive apparatus with improved reliability, capable of preventing erratic operation without lessening its capacity.

In order to achieve the above object, a disk drive apparatus according to an aspect of the invention comprises: a drive section including a disk, drive means for supporting and rotating the disk, a head configured to perform an information processing operation with respect to the disk, and a head actuator supporting the head for movement relative to the magnetic disk; a shock sensor for detecting the respective levels of a shock and a vibration externally applied to the drive section; a compensation filter for amplifying the shock and vibration levels in a frequency band corresponding to the resonance frequency of the drive section, of the shock and vibration levels detected by means of the shock sensor; and a control section configured to stop the information processing operation of the head when given values are exceeded by the external shock and vibration levels detected by the shock sensor and inputted through the compensation filter.

According to the disk drive apparatus constructed in this manner, their response is more sensitive than in other frequency bands if they are subjected to any external vibration or shock in the resonance frequency band of the drive section. Accordingly, it is hard to position the head actuator accurately, and information processing operation with respect to the disk must be interrupted quickly. Thereupon, the compensation filter can be used selectively to improve the sensitivity of the shock sensor for shocks and vibrations in the resonance frequency band, and the information processing operation can be interrupted without lessening the capacity of the apparatus.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a plan view showing a magnetic disk apparatus according to an embodiment of the invention;

FIG. 2 is a plan view showing the back of the magnetic disk apparatus;

FIG. 3 is a perspective view showing a head actuator of the magnetic disk apparatus;

FIG. 4 is a block diagram schematically showing a control system of the magnetic disk apparatus;

FIG. 5 shows a characteristic curve representing the vibration characteristic of a drive section of the magnetic disk apparatus;

FIG. 6 shows a characteristic curve representing the transfer function of a shock sensor attached to the magnetic disk apparatus;

FIG. 7 shows a characteristic curve representing the transfer function of a compensation filter attached to the magnetic disk apparatus;

FIG. 8 is a perspective view showing a head actuator of a magnetic disk apparatus according to another embodiment of the invention;

FIG. 9 is a perspective view showing a head actuator of a magnetic disk apparatus according to still another embodiment of the invention; and

FIG. 10 is a plan view showing the back of a magnetic disk apparatus according to a further embodiment of the invention.

### DETAILED DESCRIPTION OF THE INVENTION

Magnetic disk apparatuses according to embodiments of the present invention will now be described in detail with reference to the accompanying drawings.

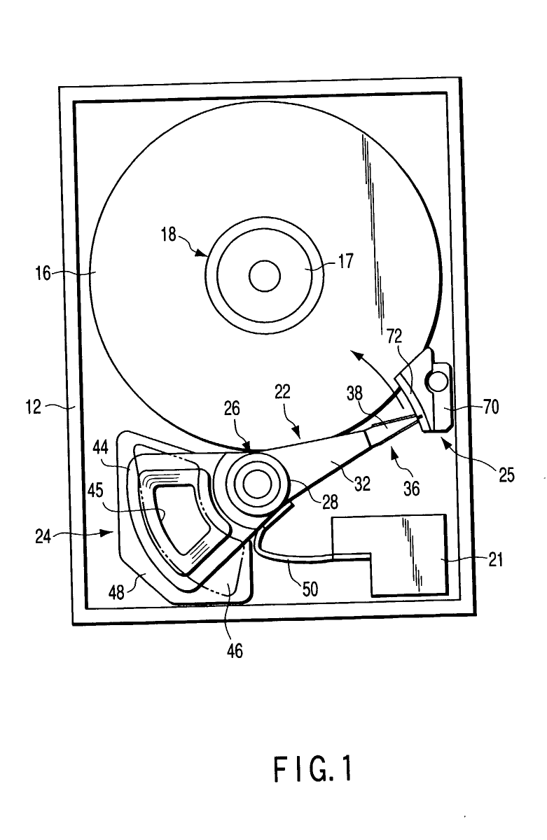

As shown in FIG. 1, an HDD comprises a casing 12 in the form of a rectangular box and a top cover (not shown) that is fixed to the casing by means of screws and closes a top opening of the casing 12.

In the casing 12 are arranged a magnetic disk 16 for use as a magnetic recording medium, a spindle motor 18 as drive means for supporting and rotating the magnetic disk, a plurality of magnetic heads for writing in and reading information from the magnetic disk, and a head actuator 22 that supports the magnetic heads for movement relative to the disk 16. The casing 12 further contains a voice coil motor (hereinafter referred to as a VCM) 24 for rocking and positioning the head actuator, a ramped loading mechanism 25 for holding the magnetic heads in positions separate from the magnetic disk, and a circuit board unit 21 including a head IC and the like.

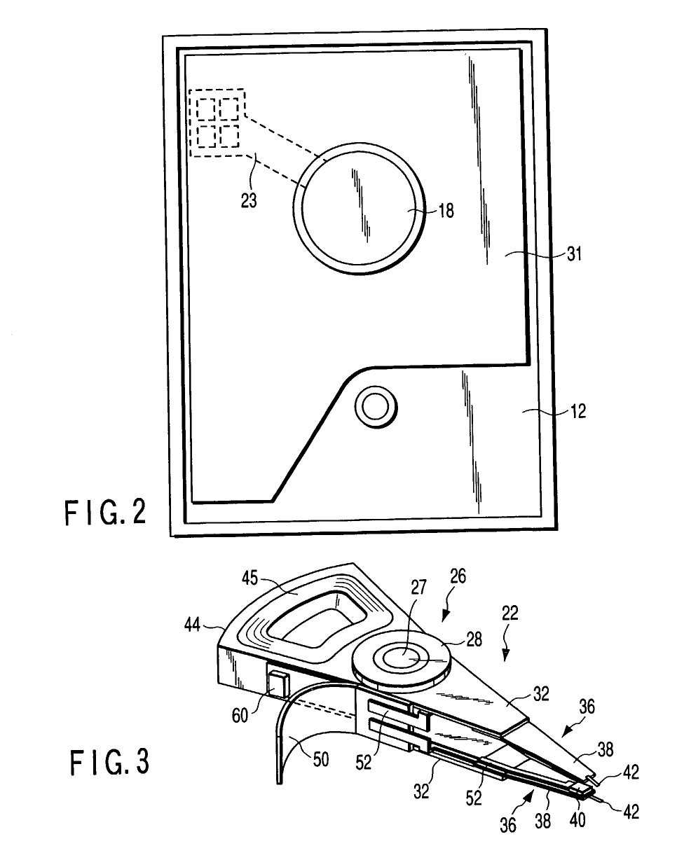

As shown in FIG. 2, a printed circuit board 31 for controlling the operation of the spindle motor 18, the VCM 24, and the magnetic heads through the circuit board unit 21 is screwed to the outer surface of the bottom wall of the casing 12. Further, a flexible printed circuit board 23 that connects the spindle motor 18 and the circuit board unit 21 is stuck on the outer surface of the bottom wall, and is situated between the casing 12 and the printed circuit board 31.

As shown in FIG. 1, the magnetic disk 16 is 65 mm (2.5 inches) in diameter and has magnetic recording layers on its upper and lower surfaces, individually. The magnetic disk 16 is fitted on a hub (not shown) of the spindle motor 18 and fixedly held by means of a clamp spring 17. As the spindle motor 18 is driven, the magnetic disk 16 is rotated at a given speed.

As shown in FIGS. 1 and 3, the head actuator 22 is provided with a bearing portion 26 fixed on the bottom wall of the casing 12 that serves as a base. The bearing portion 26 has a pivot 27 that is set up perpendicularly on the bottom wall of the casing 12 and a cylindrical hub 28 that is rotatably supported on the pivot by means of a pair of bearings. Further, the head actuator 22 is provided with two arms 32 and a plurality of spacer rings mounted on the hub 28 and magnetic head assemblies 36 supported on the arms, individually.

Each arm 32 is a flat plate of a stainless-steel material such as SUS304 having a thickness of about 250 μm, and an aperture (not shown) is formed in its proximal end. Each magnetic head assembly 36 includes a suspension 38 in the form of an elongated plate capable of elastic deformation and a magnetic head 40 fixed to the distal end of the suspension. The suspension 38 is formed of a plate spring, and its proximal end is fixed to the distal end of the arm 32 by spot welding or adhesive bonding. The suspension 38 extends from the arm 32.

The arms 32 to which the magnetic head assemblies 36 are fixed are fitted in layers on the hub 28 of the bearing portion 26 in a manner such that the hub is passed through the apertures of their respective proximal end portions. The spacer rings on the hub 28 are sandwiched between the arms 32. Thus, the two arms 32 extend parallel to each other in the same direction from the hub 28 with a given space between them. Each suspension 38 has a tab 42 that extends integrally from its distal end. The tabs 42 constitute a part of the ramped loading mechanism 25, which will be described in detail later.

The head actuator 22 has a support frame 44 that extends from the bearing portion 26 in the direction opposite to the arms 32. The support frame 44 supports a voice coil 45 that constitutes a part of the VCM 24. The frame 44 is a plastic member that is integrally molded on the outer periphery of the voice coil 45.

The magnetic disk 16 is situated between the two arms 32 with the head actuator 22 with the aforementioned configuration incorporated in the casing 12. The magnetic heads 40 that are mounted individually on the suspensions 38 individually face the upper and lower surfaces of the magnetic disk 16, thereby holding the disk 16 from both sides. Each magnetic head 40 is urged toward the surface of the magnetic disk 16 with a given head load by means of the suspension 38.

The voice coil 45 that is fixed to the support frame 44 of the head actuator 22 is situated between a pair of yokes 48 (only one of which is shown) that are fixed on the casing 12. These yokes and a driving magnet 46 that is fixed to one of the yokes constitute the VCM 24. If the voice coil 45 is energized, the head actuator 22 is rocked around the pivot 27 of the bearing portion 26 between an information processing position in which the magnetic heads 40 are situated on the magnetic disk 16 and a stop position in which the magnetic heads are situated off the outer periphery of the disk. In the information processing position, moreover, the magnetic heads 40 are moved to and positioned on desired tracks of the magnetic disk 16, and write information to and read it from the disk.

As shown in FIGS. 1 and 3, the circuit board unit 21 has a plurality of electronic components, connectors (not shown), etc. A main flexible printed circuit board (hereinafter referred to as a main FPC) 50 extends from the circuit board unit 21, and its extending end portion is fixed to a side face of the head actuator 22, especially the bearing portion 26. The main FPC 50 is connected electrically to the magnetic heads 40 through relay flexible printed circuit boards 52 that extend over the arms 32 and the suspensions 38, individually.

As shown in FIG. 1, the ramped loading mechanism 25 includes a ramp 70 that is provided on the bottom wall of the casing 12 and located outside the magnetic disk 16. The ramp 70 has a plurality of guide surfaces that correspond individually to the tabs 42 on the suspensions 38 of the head actuator 22. If the head actuator 22 is rocked toward the stop position (indicated by the solid line) by means of the VCM 24 as the HDD is shifted to its non-operating mode, the magnetic heads 40 move from the inner peripheral side of the magnetic disk 16 toward the outermost periphery. When the heads 40 move to positions near the outer peripheral edge of the disk 16, the tabs 42 that extend individually from the suspensions 38 run on their corresponding guide surfaces 72 of the ramp 70. Thereupon, the magnetic heads 40 are unloaded so that they are separated from the surfaces of the magnetic disk 16.

On the other hand, the HDD is provided with a shock sensor 60 for detecting the respective levels (gains) of a vibration and a shock that are applied externally. In the present embodiment, as shown in FIG. 3, the shock sensor 60 is attached to the support frame 44 of the head actuator 22 and located near the voice coil 45.

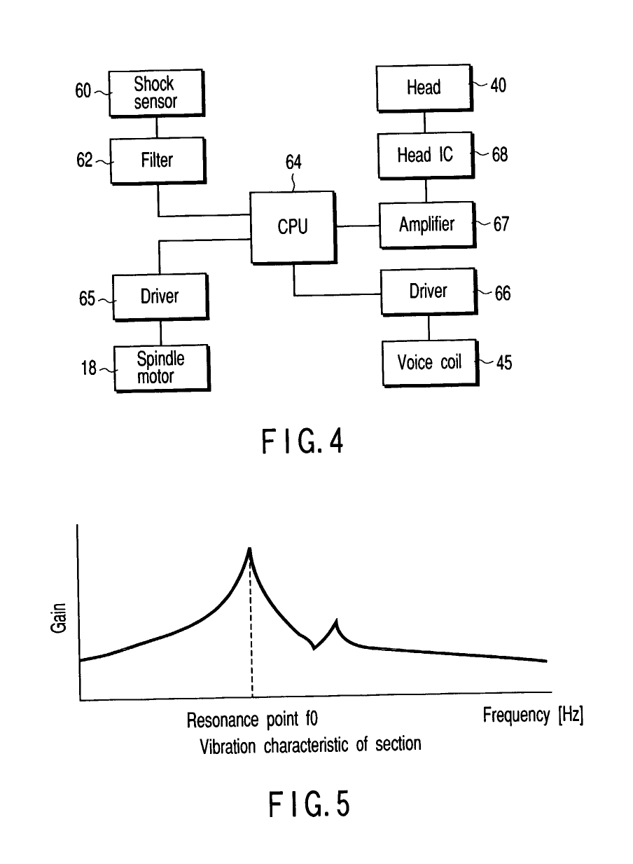

As shown in FIG. 4, the shock sensor 60 is connected to a CPU 64 through a compensation filter 62. The CPU 64 that serves as a control section is connected to the spindle motor 18 and the voice coil 45 through drivers 65 and 66, respectively, and is connected to the magnetic heads 40 through an amplifier 67 and a head IC 68.

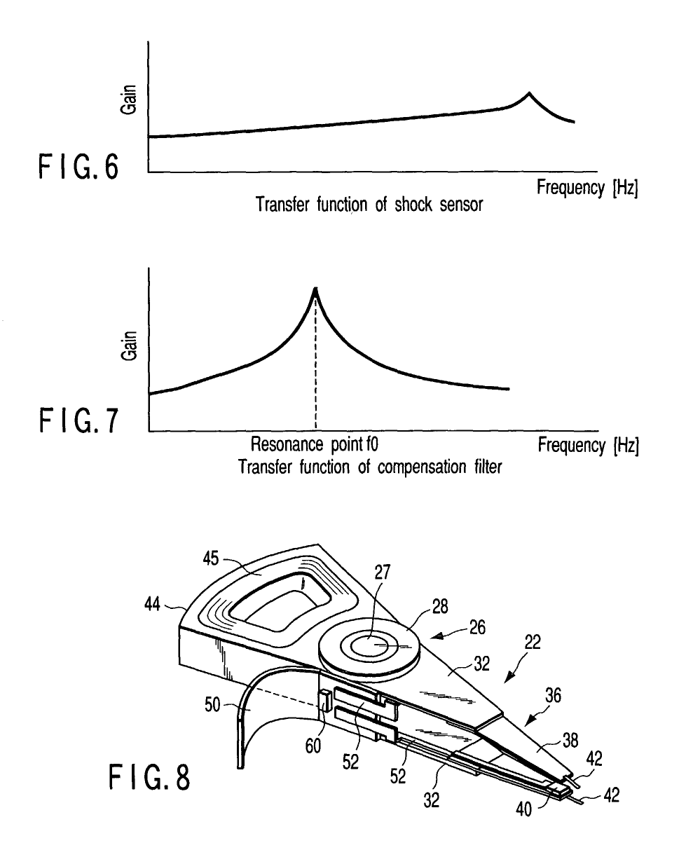

The compensation filter 62 may be either an analog filter or a digital filter that is configured to increase the sensitivity of the shock sensor with respect to the resonance frequency band of the HDD. More specifically, a drive section of the HDD, which includes the casing 12, magnetic disk 16, spindle motor 18, magnetic heads 40, head actuator 22, etc., enjoys a vibration characteristic that has a resonance point f0 near 1 kHz, for example, as shown in FIG. 5. The shock sensor 60 has the transfer function shown in FIG. 6. In this case, the compensation filter 62 is designed to have a transfer function that amplifies the gains in the resonance frequency band of the HDD drive section, as shown in FIG. 7.

Thus, the compensation filter 62 amplifies the gains in the same frequency band with the resonance point of the drive section, out of the vibration and shock gains detected by means of the shock sensor 60, by four to five times, for example, and applies them to the CPU 64. In consequence, the sensitivity of the shock sensor 60 for the vibration and shock with frequencies in the same resonance frequency band of the drive section can be increased. The CPU 64 compares a detection signal delivered from the shock sensor 60 through the compensation filter 62 with a given value (threshold value). If a gain in any frequency band is higher than the given value, the CPU 64 carries out desired operation control for the drive section of the HDD. If any vibration or shock that exceeds the given value is detected while information processing operation is being performed by the magnetic heads 40 with respect to the magnetic disk 16, the CPU 64 temporarily stops the operation of the magnetic heads 40. Foe example, if any vibration or shock that exceeds the given value is detected while information is being written in or read from the magnetic disk 16, the CPU 64 temporarily stops the writing or reading operation of the magnetic heads 40, thereby preventing writing or reading failure that is attributable to the vibration or shock.

According to the HDD constructed in this manner, the sensitivity of the shock sensor 60 for the vibration and shock can be selectively increased by providing the compensation filter 62 for amplifying the gains in the same resonance frequency band with the resonance point of the drive section of the HDD. If the sensitivity of the whole shock sensor is simply increased, the sensor excessively reacts to vibrations and shocks in frequency bands that have no influences upon the information processing operation of the magnetic heads, thereby frequently stopping the operation of the magnetic heads. The HDD according to the present embodiment can prevent this awkward result. In consequence, the HDD can securely prevent erratic operation that is attributable to external vibrations and shocks without lessening its capacity and can enjoy improved reliability.

According to the HDD constructed in this manner, moreover, the shock sensor 60 is attached to the support frame 44 of the head actuator 22 and located near the voice coil 45. Accordingly, the shock sensor 60 can enjoy characteristics that cover the vibration characteristic of the head actuator 22. If the vibration characteristic of the head actuator 22 is greatly influenced by the resonance frequency of the HDD drive section, therefore, erratic operation of the HDD attributable to external vibrations and shocks can be effectively prevented without lessening the capacity of the HDD by selectively increasing the sensitivity of the shock sensor 60 for the resonance frequency band of the head actuator.

In the embodiment described above, the shock sensor 60 is attached to the support frame 44 of the head actuator 22. However, the shock sensor can be located in other positions depending on the vibration characteristic of the HDD.

As shown in FIG. 8, for example, the shock sensor 60 may be provided on the main FPC 50 on the side face of the head actuator 22. In this case, the shock sensor 60 can also enjoy characteristics that cover the vibration characteristic of the head actuator 22. If the vibration characteristic of the head actuator 22 is greatly influenced by the resonance frequency of the HDD drive section, therefore, erratic operation of the HDD attributable to external vibrations and shocks can be effectively prevented without lessening the capacity of the HDD by selectively increasing the sensitivity of the shock sensor 60 for the resonance frequency band of the head actuator.

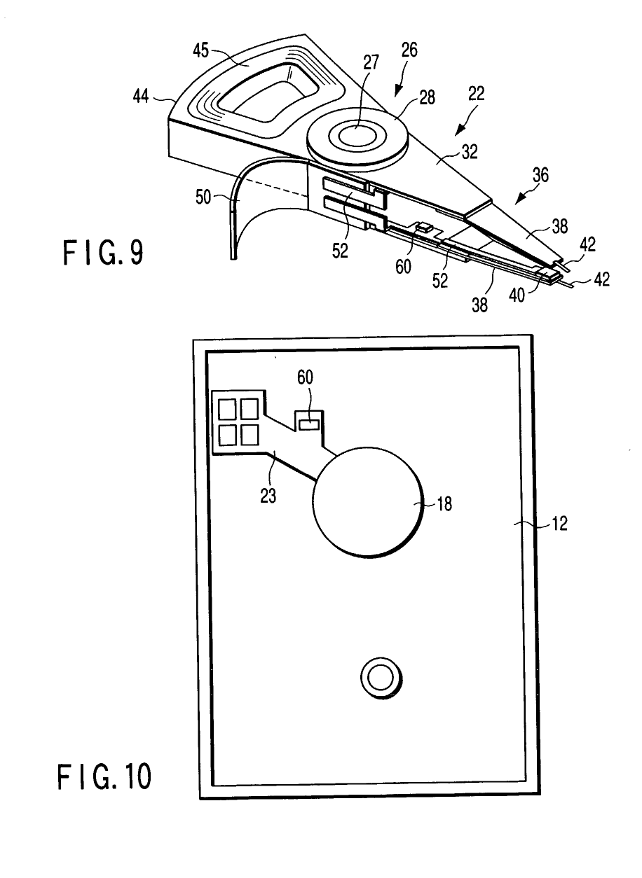

According to an embodiment shown in FIG. 9, the shock sensor 60 is provided on one of the arms 32 of the head actuator 22. In this case, the shock sensor 60 can enjoy characteristics that cover the vibration characteristic of the head actuator 22, especially that of the arms 32. If the vibration characteristic of the arms 32 of the head actuator 22 is greatly influenced by the resonance frequency of the HDD drive section, therefore, erratic operation of the HDD attributable to external vibrations and shocks can be effectively prevented without lessening the capacity of the HDD by selectively increasing the sensitivity of the shock sensor 60 for the resonance frequency band of the arms.

Further, resonance between the casing 12 of the HDD and the spindle motor 18 frequently arises a problem. According to an embodiment shown in FIG. 10, the shock sensor 60 is mounted on the flexible printed circuit board 23 that is stuck on the outer surface of the bottom wall of the casing 12.

In this case, the shock sensor 60 can enjoy the characteristics that cover the respective natural vibration characteristics of the casing 12 and the spindle motor 18. If the vibration characteristics of the casing and the spindle motor 18 are greatly influenced by the resonance frequency of the HDD drive section, therefore, erratic operation of the HDD attributable to external vibrations and shocks can be effectively prevented without lessening the capacity of the HDD by selectively increasing the sensitivity of the shock sensor 60 for the resonance frequency bands of the casing and the spindle motor 18.

The embodiments shown in FIGS. 8 to 10 share other configurations with the first embodiment. Therefore, like reference numerals are used to designate like portions of the embodiments, and a repeated description of those portions is omitted.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

It is to be understood, for example, that the resonance frequency band of the HDD drive section is not limited to 1 kHz and may be changed depending on the type, size, etc. of the HDD. Thus, the same functions and effects of the foregoing embodiments can be obtained by designing the compensation filter according to the specifications of the HDD used. Further, the shock sensor may be located in various other positions than the positions according to the foregoing embodiments.

Furthermore, the present invention is not limited to the magnetic disk apparatus and is applicable to any other recording/reproducing apparatuses such as an optical disk apparatus.

What is claimed is:

1. A disk drive apparatus comprising:
a drive section including a disk, drive means for supporting and rotating the recording disk, a head configured to perform an information processing operation with respect to the disk, and a head actuator supporting the head for movement relative to the recording disk;
a shock sensor for detecting the respective levels of a shock and a vibration externally applied to the drive section;
a compensation filter configured to amplify the shock and vibration levels in a frequency band corresponding to the resonance frequency of the drive section, of the shock and vibration levels detected by the shock sensor; and
a control section configured to stop the information processing operation of the head when given values are exceeded by the external shock and vibration levels detected by the shock sensor and inputted through the compensation filter.

2. A disk drive apparatus according to claim 1, which further comprises a base provided with the drive section, a circuit board unit located on the base, and a flexible printed circuit board electrically connecting the head actuator and the circuit board unit, and wherein the shock sensor is mounted on the flexible printed circuit board.

3. A disk drive apparatus according to claim 1, which further comprises a base provided with the drive section, and wherein the head actuator includes a bearing portion rockably mounted on the base, an arm extending from the bearing portion, and a suspension extending from the arm and fitted with the head on an extending end portion thereof, and the shock sensor is located on the arm.

4. A disk drive apparatus according to claim 1, which further comprises a base provided with the drive section, and wherein the drive section includes a voice coil motor having a voice coil attached to the head actuator and capable of driving the head actuator, and the shock sensor is attached to head actuator near the voice coil.

5. A disk drive apparatus according to claim 1, which further comprises a base provided with the drive section, and wherein the shock sensor is mounted on the base.

6. A disk drive apparatus according to claim 1, wherein the compensation filter has a transfer function for amplifying the gain of the resonance frequency band of the drive section.

7. A disk drive apparatus according to claim 1, wherein the information processing operation of the head includes an operation of writing information in the disk.

8. A disk drive apparatus according to claim 1, wherein the information processing operation of the head includes an operation of reading information from the disk.
